(19) United States
(12) Patent Application Publication
(10) Pub. No.: US 2016/0035143 A1
(43) Pub. Date: Feb. 4, 2016

(54) SYSTEM AND METHOD OF VIDEO VERIFICATION OF RFID TAG READS WITHIN AN EVENT TIMING SYSTEM

(71) Applicant: INNOVATIVE TIMING SYSTEMS, LLC, St. Louis, MO (US)

(72) Inventor: Kurt S. Hansen, Chesterfield, MO (US)

(73) Assignee: Innovative Timing Systems ,LLC

(21) Appl. No.: 14/776,584

(22) PCT Filed: Mar. 16, 2014
(86) PCT No.: PCT/US2014/030105

§ 371 Date: Sep. 14, 2015

Related U.S. Application Data
(63) Continuation-in-part of application No. 13/980,675, filed on Sep. 11, 2013.
Application No. 13/980,675 is a continuation-in-part of application No. 13/582,148, filed on Aug. 31, 2012.
Application No. 13/582,148 is a continuation-in-part of application No. 14/793,370, filed on Jul. 7, 2015.
Application No. 14/793,370 is a continuation of application No. 13/194,880, filed on Jul. 29, 2011, now Pat. No. 9,076,278.
(60) Provisional application No. 61/800,050, filed on Mar. 15, 2013.
(60) Provisional application No. 61/434,769, filed on Jan. 20, 2011.
(60) Provisional application No. 61/369,013, filed on Jul. 29, 2010.
(60) Provisional application No. 61/309,259, filed on Mar. 1, 2010.
(60) Provisional application No. 61/369,013, filed on Jul. 29, 2010.

(51) Int. Cl. G07C 1/24; G06K 7/10; G06K 9/00; H04N 7/18

(52) U.S. Cl. CPC G07C 1/24; H04N 7/181; G06K 7/10425; G06K 9/00771

(57) ABSTRACT

A system and method for determining a time of a passing of a participant by a participant detection point on a route of a timed event. The system having an image capture device capturing an image of the participant when in proximity to the image capture device positioned at the detection point on the route. The image capture device generating a captured image and transmitting the captured image. A participant identification system has a captured image interface coupled to the image capture device receiving the captured image. The participant identification system analyses the received captured image including the identifying of an identification of the participant and then transmitting the captured image and the participant's identification. A timing system receives the transmitted captured image and the participant identification, and determines the time of passing of the participant by the participant detection point on the route of the timed event responsive thereto.

### CROSS-REFERENCE TO RELATED APPLICATIONS

This application claims the benefit of U.S. Provisional Application No. 61/800,050, filed on Mar. 15, 2013, the disclosure of which is incorporated herein by reference.

### FIELD

The present disclosure relates to timing systems and, more specifically, to a timing system having an integrated image or video capture and recognition capability for determining the identification of the participant in an event.

### BACKGROUND

The statements in this section merely provide background information related to the present disclosure and may not constitute prior art.

RFID tag reader systems (TRS) are used to track RFID tags often must be able to detect numerous tags crossing a detection point within a very short period of time. For example, RFID tag reader systems are often used in sporting events to time participants of such events. In such applications, that include marathon races, the RFID tag readers for the sports timing systems have a very difficult job as they are required to read hundreds, or perhaps thousands of timing participant identifiers as they cross a start, split, or finish line. The technology typically used by other systems can very susceptible to electrical interference, weather, and other factors. The RFID race timing systems operates at an ultra-high frequency and is less susceptible to interference. This helps reduce the number of problems the user might experience on race day. Many such systems use a passive participant identifier that does not require a battery. The participant identifier operates in the Ultra-High Frequency (UHF) range, which provides a more consistent and clean signal. Some of these systems often use low frequency (LF) participant identifiers that can be susceptible to interference from things like electrical power lines, rebar in concrete roads, mobile telephone systems or storms. UHF signals travel in a direction commonly referred to as line-of-sight. This simply means that the signal is highly concentrated in a single direction, and that is why it works so well for timing races.

When using an RFID system or similar detection technology system for timing sporting events, it often becomes necessary to obtain additional participant information related to a participant in an event. Typically, photographs and video can be taken by a user positioned along the course of the event such as along a particular reference point such as a waypoint or finish line. These users take the photos and associate such with the time of the passing of the participant by the photo point, the name of the participant, or a bib or other participant number or code. The participants are provided with such identifying data and the photos are placed in a database, catalogued, and later accessed by a user by such identifying data. The accessed database can be searched with the photos displayed, and wherein the party doing such searching and displaying can inspect and order the photos, such as via a web site such as provided by U.S. Pat. Nos. 6,985,875 and 7,047,214. It is also possible with certain system that a photovoltaic detection system such as disclosed in U.S. Pat. No. 6,768,094 can be used to electronically trigger a photographic system for taking a photo image participant that passes the trigger mechanism line.

However, such current systems are not integrated into the event timing systems that utilized RFID tag detection and tag reading technology. Furthermore, the current process is limited by both the human factors of attempting to take the photographic image, associating such image with the participant and the identifying data, such as name, time or bib number, and then cataloging in a database for subsequent searching, review and ordering. Such human involvement is labor intensive, is prone to errors, and often receives unsatisfactory reviews by participants. Further, when there are a large number of participants passing a particular event course location, it is impossible for current systems to take photos of every participant and to associate every participant in a photo with a participant identifier for subsequent association and cataloging, thereby limiting the ability of the current system to have photos available for on-line review and ordering by numerous participants. Such systems and limitations also make it very difficult if not impossible for an event photographer to pre-subscribe numerous participants in an event, as the failure rate and complexity in ensuring that such photographers can in fact take a photograph of each pre-subscribed participants that can subsequently be associated, informed, catalogued, accessed, searched, and reviewed.

While current RFID readers can have an overall participant identifier read success can range from 98.0% to 100% with as many as 30 participants crossing a finish line within a 1-second period, some tags cannot be read and their passing of the detection point information is never automatically recorded by the RFID readers. As such, there is a need for providing methods and systems for enabling supplemental tag reads. The inventor hereof has identified the problems of using an RFID tag reading system for timing sporting events where there are a large number of participants, and the system experiences a failure to read 100% of the RFID tags worn by the participants. The inventor has identified the need to ensure that timing information is collected for as many participants as possible including 100 percent.

As such, the inventor hereof has identified a need for an integrated photographic and video image system that is integrated with the RFID tag reader and/or timing system for verifying the identity of the participant or the participants bib or bib tag number during the passing at a monitored point.

### SUMMARY

The inventor hereof has succeeded at designing an improved timing system with video capture and image verification and timing determination based at least in part thereon.

In one aspect, a system for determining a time of a passing of a participant by a participant detection point on a route of a timed event. The system having an image capture device capturing an image of the participant when in proximity to the image capture device positioned at the detection point on the route. The image capture device generating a captured image and transmitting the captured image. A participant identification system has a captured image interface coupled to the image capture device receiving the captured image. The participant identification system analyzes the received captured image including the identifying of an identification of the participant and then transmitting the captured image and the participant's identification. A timing system receives the transmitted captured image and the participant identification, and determines the time of passing of the participant by the participant detection point on the route of the timed event responsive thereto.

In another aspect, a system for determining a time of a passing of a participant by a participant detection point on a route of a timed event with the system including an RFID tag including a participant number as an RFID tag number, the RFID tag being associated with the participant during the event and a RFID tag reader positioned at the participant detection point communicating with an RFID tag of the participant and receiving the RFID tag number of the RFID tag in one or more RFID tag reads. The tag reader identifies a time of each RFID tag read and transmits the tag read and tag read time. An image capture device captures an image of the participant when in proximity to the image capture device positioned at the participant detection point and generates a captured image and transmitting the captured image. A participant identification system includes a captured image interface coupled to the image capture device receiving the captured image, and analyzes the received captured image including identifying an identification of the participant. Afterwards, it transmits the captured image and the participant's identification. A timing system receives the transmitted captured image and the participant identification from the participant identification system and receives the tag read and the tag read time from the RFID tag reader. The timing system determines the time of passing of the participant by the participant detection point on the route of the timed event responsive each of the received tag read, the tag read time and the received captured image.

In still another aspect, a method of determining a time of a passing of a participant by a participant detection point on a route of a timed event that includes the processes of capturing an image of the participant by an image capture device when in proximity to the image capture device positioned at the detection point on the route with the image capture device generating a captured image and transmitting the captured image. The method includes receiving the captured image, analyzing the received captured image including identifying an identification of the participant and transmitting the captured image and the participant's identification, and then determining the time of passing of the participant by the participant detection point on the route of the timed event responsive thereto.

In another aspect, a method for determining a time of a passing of a participant by a participant detection point on a route of a timed event includes receiving a RFID tag read including an RFID tag number associated with the participant, and identifying an RFID read time for the received RFID tag read, and transmitting the RFID tag read and tag read time. The method also includes capturing an image of the participant by an image capture device when in proximity to the image capture device positioned at the detection point on the route with the image capture device generating a captured image and transmitting the captured image. The method also includes receiving the captured image and analyzing the received captured image including identifying an identification of the participant and transmitting the captured image and the participant's identification. The method further includes receiving the transmitted captured image and the participant identification and receiving the tag read and the tag read time. The method then determines the time of passing of the participant by the participant detection point on the route of the timed event responsive each of the received tag read, the tag read time and the received captured image.

Further aspects of the present disclosure will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIG. 1 is an illustration of a system and method for determining a time of a passing of a participant by a detection line along a traveled route using RFID tags, antennas and RFID tag reader systems as known in the art.

FIG. 2 is an RFID timing system utilizing an image capture device for verifying the identifying the identity of the participant such as the face and/or an image of the participants bib or bib number in addition to the RFID tag read according to one exemplary embodiment.

FIG. 3 is a schematic of a participant approaching a monitored line on an event track having four RFID tag reader antenna and one image capture device for capturing the image of the participant and/or an image of the bib tag number of the participant according to one embodiment.

FIG. 4 is a schematic of a participant approaching a monitored line on an event track having three image capture devices for capturing images of the participant and/or an image of the bib tag number of the participant according to one embodiment.

FIG. 5 is a schematic of a participant approaching a monitored line on an event track having four RFID tag reader antennas at a first monitored point and a plurality of image capture devices at a second monitored point that is offset and spaced apart from the first monitored point for capturing images of the participant and/or an image of the bib tag number as a backup to the RFID tag read according to one embodiment.

FIG. 6 is a block diagram of an integrated timing system with image capture and image recognition and OCR.

FIG. 7 is a listing of communication messages and formats that are suitable for use by the disclosed system and method.

FIG. 8 is a flow diagram of a process for tag reading with image capture and optical character recognition of a bib tag of the participant along with image processing within the timing system according to one embodiment.

FIG. 9 is a sample display screen showing a course or event route layout and the tracking of the participant over the course including the times of passing of the various points and the displaying of images of the participants as captured at the one or more detection or monitored points.

FIG. 11 illustrates an exemplary computer system environment according to one embodiment.

FIG. 12 illustrates an exemplary client-server environment according to yet another embodiment.

It should be understood that throughout the drawings, corresponding reference numerals indicate like or corresponding parts and features.

### DETAILED DESCRIPTION

The following description is merely exemplary in nature and is not intended to limit the present disclosure or the disclosure's applications or uses.

In one aspect, a system for determining a time of a passing of a participant by a participant detection point on a route of a timed event. The system having an image capture device capturing an image of the participant when in proximity to the image capture device positioned at the detection point on the route. The image capture device generating a captured image and transmitting the captured image. The image capture device can be any type of system including a cell phone, a camera, a video camera, and a photo camera.

A participant identification system has a captured image interface coupled to the image capture device receiving the captured image. The participant identification system analyzes the received captured image including the identifying of an identification of the participant and then transmitting the captured image and the participant's identification. The participant identification system can identify the participant identification by any suitable means including optical recognition technology with integrated capabilities such as automatic cropping, digital zoom, and image linking to an RFID tag read, a laser timing read, and a received participant location or other means as described herein and known to those of skill in the art after reviewing this disclosure. A timing system receives the transmitted captured image and the participant identification, and determines the time of passing of the participant by the participant detection point on the route of the timed event responsive thereto.

In some embodiments, at least one of the image capture device and the participant identification system includes a clock and associates an image capture time with the captured image, and wherein the image capture time is received by the timing system and the timing system determines the time of passing at least in part based on the image capture time.

The captured image can be any image, but in some embodiments, the captured image is an image of a participant number worn by the participant. The process of analyzing by the participant identification system can include optical character recognition or object recognition and the of the participant's identification such as the participant's number or tag number from the captured image. This can be an Arabic number, a QR Code and/or a Bar Code that includes the participant number or identification of the participant. The timing system receives the identified participant number and determines the participant's number with the determined time of passing. In another embodiment, the captured image is an image of a face of the participant, and wherein the analyzing by the participant identification system includes facial recognition and the identifying includes identifying the face of the participant from a comparison of a stored image of the participants face with the captured image and associating the identified face with a participant number, and wherein the timing system receives the identified participant number and determines the participant's number with the generated time of passing.

In some embodiments, the system also includes an RFID tag including a participant number as an RFID tag number with the RFID tag being associated with the participant during the event. The RFID tag reader is positioned at the participant detection point communicating with an RFID tag of the participant and receives the RFID tag number of the RFID tag in one or more RFID tag reads. The RFID tag reader also identifies a time of each RFID tag read and transmits the tag read and tag read time to a timing system. In this case, the timing system determines the time of passing as a function of the tag read and tag read time and the received captured image. In some embodiments, the timing system verifies the identification of the participant as determined from the captured image with that as determined from the received tag read. This can include the timing system determining the time of passing of the RFID tag read time responsive to a successful verification.

In some embodiments, the timing system determines the participant number from the tag read and associates the captured image with the identified participant, and stores the captured image in a database file that is associated with the participant number and/or the RFID tag number. The timing system can also provide the image capture device with the RFID tag number from the tag read and the image capture device includes the received RFID tag number with the captured image that is transmitted to the participant identification system.

In some embodiments, the image capture device is coupled to the RFID tag reader and the RFID tag reader system or the timing system generates an image capture request to the image capture device to obtain a captured image responsive to the RFID tag reader receiving a tag read. The captured image is obtained responsive to the request. For instance, in some embodiments, the RFID tag reader detects the RFID tag number approaching the participant detection point, and at least one of the RFID tag reader, the timing system, and the participant identification system determines a need for capturing an image of the participant with the RFID tag approaching the participant detection point. Such system then generates an image capture request to the image capture device to obtain a captured image and the image capture device captures the captured image.

In some embodiment, the RFID tag reader receives tag read and the timing system detects the RFID tag number approaching the participant detection point, and determines there is an image capture event for capturing an image of the participant with the RFID tag approaching the participant detection point. In such a case, an image capture request can be generated to the image capture device to obtain a captured image, and wherein the captured image is responsive thereto. In some embodiments, the timing system determines that the image capture event as a function of the timing system verifying of the identification of the participant approaching the participant detection point, the verifying being responsive to a determined image capture event selected from the group of events including a predefined request, a subscription, an RFID tag reader error, a timing system error, and an inability of the tag reader or the timing system to determine the participant number or RFID tag number.

In some embodiments, the participant identification system identities the identification of the participant by analyzing a unique identifier of the captured image and integrates that unique identifier with received tag read for confirming the time of passing.

The timing system can have an output interface and transmits over the output interface the captured image, the participant identification and the determined time of passing. In such cases, the timing system can retrieve from storage or a communicatively coupled device or from within information on the participant after the identifying by the participant identification system and the timing system transmits the retrieved information over the output interface along with the captured image, the participant identification and the determined time of passing. This can also include retrieving information on the participant and then transmitting the captured image, the participant identification and the determined time of passing to a network device communicatively coupled to the output interface as defined by the retrieved information, such as an identified recipient device or system.

In some embodiments, a location device is associated with the participant and determines a location of the participant on the route. The determined location is transmitted and then received by the timing system and the image capture device captures the captured image responsive to a request thereto. In a complete different variation, the timing system itself can determine at least partially from the received captured image the location of the participant on the route, or a speed of the participant along the route.

In some embodiments, there are multiple image capture devices associated with the participant detection point and the participant identification system receives multiple captured images from one or more of the plurality of image capture devices. The participant identification system can perform the identifying through triangulation or comparing two or more captured images from two or more image capture devices.

In another embodiment, a system for determining a time of a passing of a participant by a participant detection point on a route of a timed event with the system including an RFID tag including a participant number as an RFID tag number, the RFID tag being associated with the participant during the event and a RFID tag reader positioned at the participant detection point communicating with an RFID tag of the participant and receiving the RFID tag number of the RFID tag in one or more RFID tag reads. The tag reader identifies a time of each RFID tag read and transmits the tag read and tag read time. An image capture device captures an image of the participant when in proximity to the image capture device positioned at the participant detection point and generates a captured image and transmitting the captured image. A participant identification system includes a captured image interface coupled to the image capture device receiving the captured image, and analyzes the received captured image including identifying an identification of the participant. Afterwards, it transmits the captured image and the participant's identification. A timing system receives the transmitted captured image and the participant identification from the participant identification system and receives the tag read and the tag read time from the RFID tag reader. The timing system determines the time of passing of the participant by the participant detection point on the route of the timed event responsive each of the received tag read, the tag read time and the received captured image.

In other embodiments, a method of determining a time of a passing of a participant by a participant detection point on a route of a timed event that includes the processes of capturing an image of the participant by an image capture device when in proximity to the image capture device positioned at the detection point on the route with the image capture device generating a captured image and transmitting the captured image. The method includes receiving the captured image, analyzing the received captured image including identifying an identification of the participant and transmitting the captured image and the participant's identification, and then determining the time of passing of the participant by the participant detection point on the route of the timed event responsive thereto.

The method can include, where the captured image is an image of a tag number on the participant. This can be an Arabic number, a QR Code and/or a Bar Code that is positioned on a bib or shirt of the participant. Such can also include not only the participant tag number, but also the participant's name or that otherwise uniquely identifies the participant number. The method includes analyzing such as by optical character recognition or object recognition and the identifying includes identifying the participant number of the participant from the captured image. The process of determining the time of passing can include determining the participant's number and associating the participant's number with the determined time of passing. Where the captured image is an image of a face of the participant, the analyzing by the participant identification system includes facial recognition and the identifying of the face of the participant from a comparison of a stored image of the participants face with the captured image and associating the identified face with the participant or participant number.

In another embodiment, a method for determining a time of a passing of a participant by a participant detection point on a route of a timed event includes receiving a RFID tag read including an RFID tag number associated with the participant, and identifying an RFID read time for the received RFID tag read, and transmitting the RFID tag read and tag read time. The method also includes capturing an image of the participant by an image capture device when in proximity to the image capture device positioned at the detection point on the route with the image capture device generating a captured image and transmitting the captured image. The method also includes receiving the captured image and analyzing the received captured image including identifying an identification of the participant and transmitting the captured image and the participant's identification. The method further includes receiving the transmitted captured image and the participant identification and receiving the tag read and the tag read time. The method then determines the time of passing of the participant by the participant detection point on the route of the timed event responsive each of the received tag read, the tag read time and the received captured image.

The method can include verifying the identification of the participant as determined from the received captured image with that as determined from the received tag read and wherein determining the time of passing of the RFID tag read time is responsive to a successful verification. This can be an Arabic number, a QR Code and/or a Bar Code that includes the participant number or identification of the participant.

In some embodiments, the method includes determining the participant number from the tag read associating the captured image with the identified participant, and storing the captured image in a database file that is associated with the participant number and/or the RFID tag number.

In some embodiments, the method includes generating an image capture request to the image capture device to obtain a captured image responsive to the RFID tag reader receiving a tag read, and wherein the capturing of the captured image is responsive thereto. In other embodiments, the method includes detecting via an RFID tag reader the approaching of the participant to the participant detection point, determining a need for capturing an image of the participant with the RFID tag approaching the participant detection point, and generating an image capture request to the image capture device to obtain a captured image, and wherein the capturing of the captured image is responsive thereto. For example, this can include receiving the tag read at the RFID tag reader, and detecting by the timing system the RFID tag number that is approaching the participant detection point, determining an image capture event for capturing an image of the participant with the RFID tag approaching the participant detection point, and generating an image capture request to the image capture device to obtain a captured image, and wherein the capturing of the captured image is responsive thereto.

In some embodiments, the method includes determining the image capture event is a function of the timing system verifying of the identification of the participant approaching the participant detection point. The verifying can be responsive to a determined image capture event selected from the group of events including a predefined request, a subscription, an RFID tag reader error, a timing system error, and an inability of the tag reader or the timing system to determine the participant number or RFID tag number.

In some embodiments, the method includes identifying the identification of the participant by analyzing a unique identifier of the captured image and integrating the unique identifier with received tag read for confirming the time of passing.

In some embodiments, wherein there is a plurality of image capture devices associated with the participant detection point, the method can include receiving a plurality of captured images from one or more of the plurality of image capture devices and the identifying includes triangulation or comparing of two or more captured images from two or more image capture devices.

In some embodiments, a system and/or method for determining a time of a passing of a participant passed a detection line on a route includes an image capture device capturing one or more images of the participants at an image monitored point, the image capture device generating image data in an image message over a data interface responsive to the capturing of the images, an image capture system communicating with a timing system and the image capture device for receiving the generated image message, and creating an image capture message including the image data, and transmitting the image capture message over the communication interface to the timing system that identifies an identity of the participant by comparing the received image within the image capture message with a listing of participants, and verifying a received timing of passing of the detection line as being the time of passing of the image identified participant.

In other embodiments, a system and/or method provides for determining a time of a passing of a participant passed a detection line on a route based on a captured image of the participant. An RFID tag reader system configured for communicating with an RFID tag of the participant and obtaining the RFID tag number of the RFID tag in one or more RFID tag reads, time stamping each RFID tag read, and transmitting over a communication interface a tag read message including the RFID tag number to the timing system. An image capture device configured for capturing one or more images of the participants when in proximity to the image capture device at an image monitored point, the image capture device generating image data in an image message over a data interface responsive to the capturing of the one or more images. An image capture system configured for communicating with a timing system and an interface coupled to the image capture device for receiving the generated image message, and creating an image capture message including the image data, and transmitting the image capture message over the communication interface to the timing system. The timing system receives the tag read message and the image capture message, identifying an identity of the participant by comparing the received image within the image capture message with a listing of participants, and verifying a received timing of passing of the detection line as received from the RFID tag reader as being the time of passing of the image identified participant.

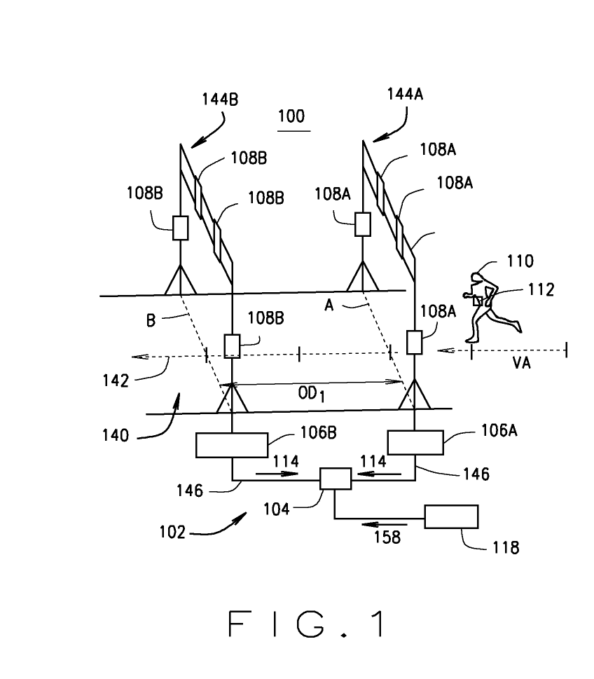

Referring now to the Figures, FIG. 1 is a system 100 that includes an event participant management system 102 illustrating event participation system 102 with a timing system 104. The timing system 104 includes one or more tag readers 106 and antenna 108. A participant 110 travels along event course 140 and participant travel path 142 therein and traveling at a speed of VA. The participant has an RFID tag 112 (sometimes referred as a chip) that has a unique tag identifier. As shown in FIG. 1, the system 100 can include more than one detection point shown as two detection points A and B that are spaced apart by distance OD1. Detection point A is monitored by participant identification system 144A using tag reader 106A using antenna 108A and detection point B is monitored by participant identification system 144B using tag reader 106B using antenna 108B. Each tag readers 106A and 106B (referred commonly as tag reader 106) using the antenna 108A and 108B, respectively (referred commonly as antenna 108) obtains a plurality of an RFID tag read messages 114 (referred herein shortened as tag read 114) that includes the tag identifier, and transmits the tag identifier to the timing system 104 as the participant 110 traverses along path 142.

As shown the timing system 104 is coupled to both tag reader reading systems, a first participant identification system 144A is located along course 140 at point A and includes a plurality of antenna 108A coupled to tag reader 106A. A second participant identification system 144B is located along course 140 at point B that includes antenna 108B coupled to tag reader 106B. Point A is spaced apart from point B at a distance OD1 along course 140. Distance OD1 can be only few feet or can be split points such as miles or kilometers apart along course 140, such as a start line, a split point or a finish line, by ways of example. Each tag read 114 and associated measured biometric data 120 is correlated to the particular point A and point B and such can be provided to biometric module 116 for use in analysis and reporting.

As shown, as the participant 110 with RFID tag 112 approaches and passes each of points A and B, each participant identification system 144A, 144B receives one or more tag reads 114 from the RFID tag 112 using tag readers 106A, 106B transmits each tag read 114 to the timing system 104 via communication link 146. A participant management system 118 is communicatively coupled to timing system 104 for providing participant information such as registration information, assignment of a unique tag identifier to each registered participant 110 and therefore assignment of each RFID tag 112 to each participant 110. Furthermore, the participant management system 118 can provide other features and data in support of the video verification of tag reads 118 as will be further described herein.

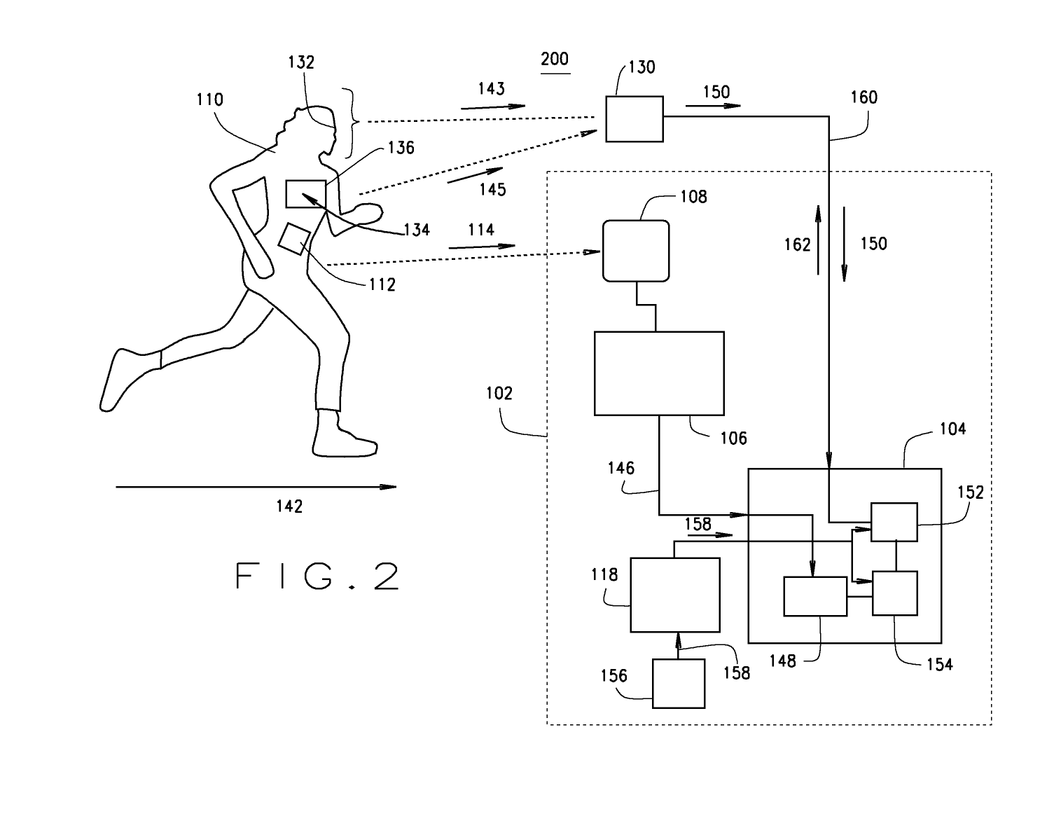

Referring now to FIG. 2, the system 200 includes a similar participant management system 102 having the timing system 104 with tag reader 106 and antenna 108 for obtaining the tag reads 114 from the RFID tag 112 of the participant 110. However, in this embodiment of system 200, the system 102 includes one or more image capture devices 130 that verify the identity of the participant 110 for the tag read 114 of the tag readers 106. As illustrated, the image capture device 130 is a still or video camera positioned along course and path 142 that is typically, but not necessarily, proximate to a participant identification system 144 (such as 144 A or 144B of FIG. 1). Of course one skilled in the art would understand that the image capture device 130 could be separately positioned apart from either of detection points A and B.

Each participant 110 has a unique face 132 and a unique participant tag number 134 such as one displayed on a bib 136 worn by the participant 110. The image capture device 130 can obtain an image 143 of the face 132 of the participant 110 and/or an image 145 of the tag number 134 such as an Arabic number, a QR Code and/or a Bar Code that includes the participant number or identification of the participant 110 such as displayed on the bib 136 or possibly on a shirt worn by the participant 110. The image capture device 130 can obtain facial image 143 or tag number image 145 as well as other images of the participant 110 or portions thereof, which will commonly be referred herein as captured images 150. The captured images 150 are transmitted by the image capture device 130 to an image capture interface 152 that is coupled to a participant recognition system or module 154, which can be a separate component, system or a module within the timing system 104, the event management system 102 or the participant identification system 144. The participant processing system 154 received the images 150 from the image capture interface 152.

The timing system 104 includes a RFID tag reader interface 148 that is communicatively coupled to the one or more tag readers 106 for managing the tag readers 106 including the reading of the RFID tags 112 and obtaining the tag reader 114 that include the tag identifiers thereof. The tag reader interface 148 obtains from the tag reader the tag identifiers as well as a time stamp of tag read time associated with each tag read 114. As known in the RFID tag reader timing system art, the tag reads 114 providing the timing system 104 the ability to determine the passing time of the participant 110 by detection points such as detection points A and B of FIG. 1. In this manner, the typical timing system 104 tracks and reports the participant's timed effort in the event. However, as known in the art, RFID tag reads 114 often do not capture 100 percent of all participants 110 that pass by each detection point for various known reasons in the art of RFID technology and event timing systems. However, the present system 200 has improved upon the prior systems by integrating the capturing of images 150 into the timing system 104 by receiving the images 150 via the image capture interface 152 into the participant recognition system 154.

The image recognition system 152 receives the images 150 and stores them and executes image recognition software as known in the industry or that may be specially developed for recognizing the participant number 134 within image 145 or for recognizing the face 132 from image 143 and identifying a name or number of the participant 110. Object recognition software and modules as well as facial recognition systems and software can provide for the automatic identifying or verifying of a participant from an image or video provided as image 143. One way this can be performed by participant recognition system 154 is the comparing of selected facial features from stored images 158 that were obtained via a participant registration system 118 and an image providing user interface 156.

Object and facial recognition software applications running in image recognition system 152 utilize algorithms the identify features by extracting landmarks or features and analyzing relative sizes, color, shapes, configurations and textures. For example, shapes and arrangements of numbers and size, color shape, texture and/or configuration of eyes, nose, cheekbones, jaw and hair. These features are then used to search and compare against stored images 158 of a plurality of numbers and participant images that are predefined or stored such as prior to the event in a registration system 118 or the like. The participant recognition system 154 can utilize any suitable software application including two and three dimensional recognition or any new technology that may be developed. As noted, the participant registration system 118 can receive a participant image 158 of the participant 110 prior to the start of the event such as during registration via a user interface device 156 and such participant image 158 is provided by the system 118 to the timing system 104 or to the image capture interface 152 or to participant recognition system 154 for performing such participant identification. This may not be required wherein the image 150 only includes participant number image 145 in which case the participant recognition system 154 would be configured for object recognition of the bib or participant number 134.

As will be discussed, the timing system 104 receives the identification of the participant 110 or the participants number 134 from the participant identification system 154. The image capture device 130 can also provide a time stamp for each image 150 wherein the time of the captured image 150 can also be provided to the timing system 104. The timing system 104 then utilizes the identification of the participant from the participant identification system 154 along with the time in supporting or verifying or providing a time of the participant 110 passing by a detection point. This can be used by the timing system 104 alone for determining the passing of the passing of the particular participant 110 or can be used to verify the tag read 114 as received from tag reader 106. The identification of the participant 110 by the participant identification device 154 can include the identification of the participant number 134 that can be compared to the participant identifier as provided by the tag read 114 either in real time as a verification thereof, or can be saved or stored in the system 104 for use later to participant verification and validation. Of course, the captured image 150 once identified as being associated with a particular participant 110, can also be provided to a third party image output such as for displaying or transmitting for use by a third party or to a participant user device.

Further, the timing system 104 can be used to trigger the image capture device 130. For instance, the tag reader 108 can receive a tag read 114 and provide that to the timing system 104. The timing system 104 can then initiate, based on a prior defined need, subscription or otherwise, a request 162 to the image capture device to capture an image of the participant 110 or at least an attempt to capture an image of the participant 110 due to the proximity of the image capture device 130.

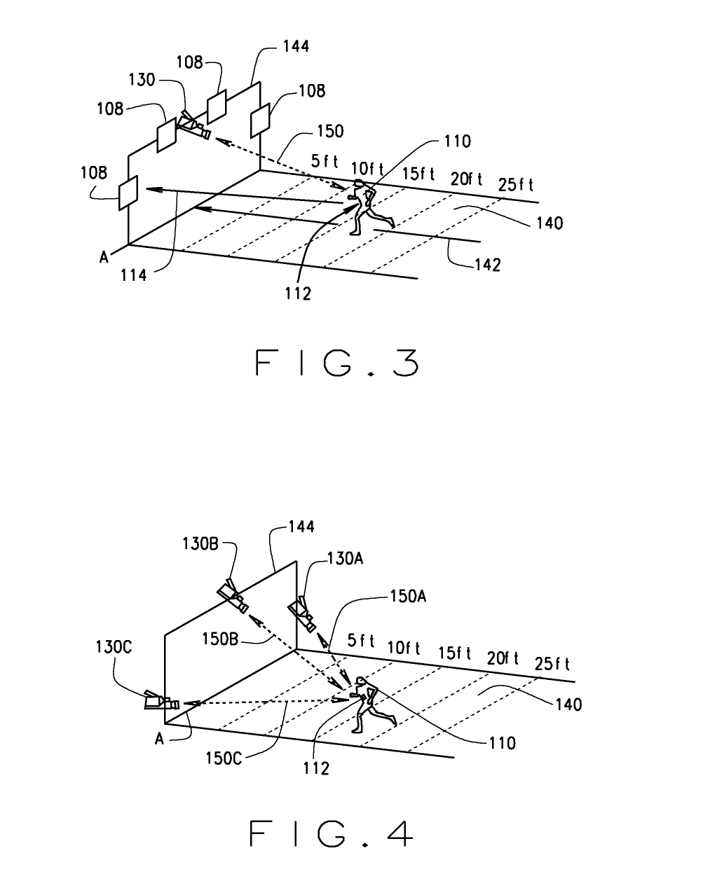

FIG. 3 illustrates one embodiment of positioning of a single video camera 130 at participant identification system 144 that also includes a plurality of RFID antenna 108. As the participant 110 approaches detection point A and its associated participant identification system 144, the RFID antenna 108 captures the tag read 114 while the image capture device 130 captures an image 150 associated with the participant 110 traveling path 142 along course 140 and in proximity to participant identification system 144 at detection point A.

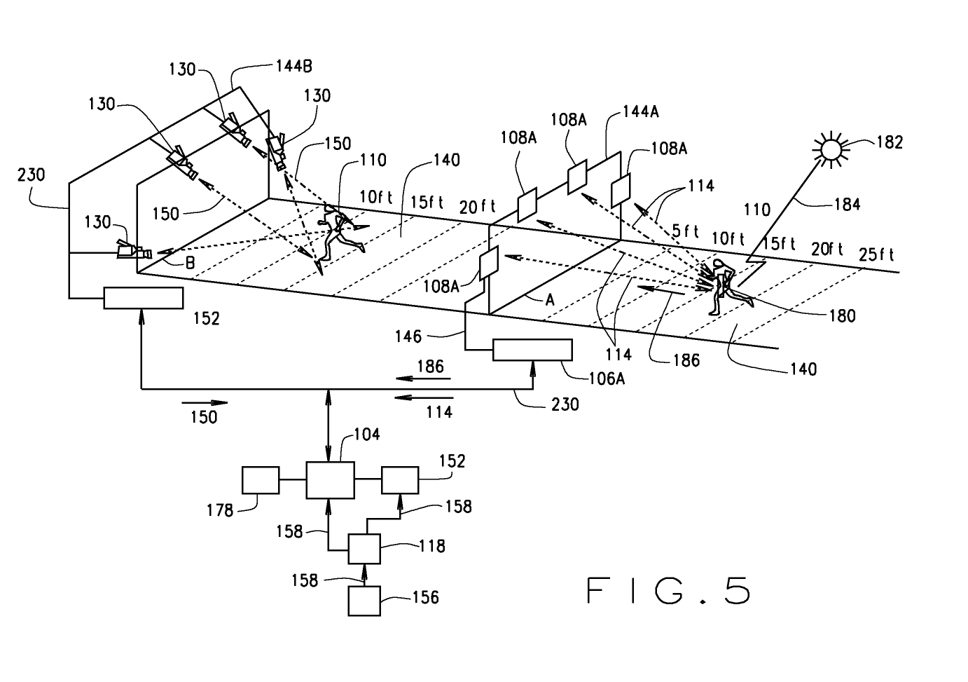

FIG. 4 illustrates an embodiment of participant identification system 144 that only includes image capture devices 130A, 130B, and 130C for capturing images 150A, 150B, and 150C respectively of the participant. No RFID antenna 108 or tag readers 106 are needed or provided in this embodiment of participant identification system 144 of FIG. 4.

FIG. 5 illustrates another event timing system embodiment that is a combination of various participant identification modules and components that combine those shown and discussed above with regard to FIGS. 1, 2 3 and 4. The system of FIG. 5 also includes a location detection system 178 that is coupled or within the timing system 104. In this embodiment, the timing system 104 includes an optional GPS tracking capability. The participant 110 can include a GPS locator 180 that receives GPS location data 184 from a plurality of GPS transmitters 182 which are usually satellites. The participant location data 186 can also be transmitted to the timing system 104 and the location data 186 can be integrated with or utilized in the analysis of the participant identification system 154. The timing system 104 can utilize the received participant location data 186 to initial the capturing of a participant image 150 by one or more of the image capture devices 130. The location data 186 can be associated with the participant image 158 and/or tag read 114 with its times to also act as a further verification of the identification of the participant 110 and an image 150 of such participant 110 such as in embodiments where no prior received image 158 is received by the system of particular participant 110.

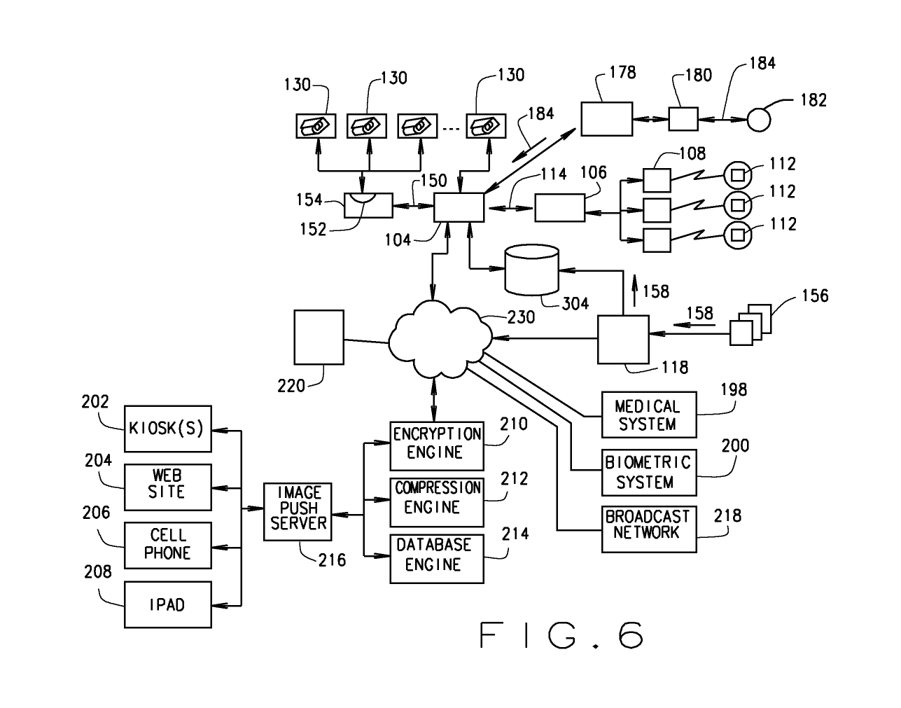

FIG. 6 is a block diagram of an integrated timing system with image capture and image recognition and OCR. The participant management system 102 has the event timing system 104 that is communicatively coupled to RFID tag 112 for receiving tag read 114 from tag readers 106 with their antenna 108 as well as captured images 150 from image capture devices 130 via participant identification system 154. The timing system 104 is also communicatively coupled via a data network 230 such as a wireless network to participant registration system 154 for receiving participant images 158. The participant registration system 118 is accessed by a user or participant by using one or more user device 156 for inputting user data as well as participant image 158 that can be utilized by the timing system 104 or the participant identification system 154 as described above. This can also include the identification or authorization of participant defined outputs for providing any captured images 150 associated with the particular participant 110. This can include providing a captured image 150 that is identified by the system 154 as being that of the participant 110 to a telephone number for text messaging, to a url or to an IP address such as a website or user name for a website. The outputs for the providing of a captured image 150 of a particular identified participant 110 can include an image library 220, a biometric module 200, an event or participant medical system 198, an event announcer or broadcast network 218, a kiosk or billboard 202, a web site 204, a mobile or cell phone 206, or another mobile device 208, with any of these being via an application or messaging format or system as may be desired or suitable. The system can include an encryption engine 210, a compression engine 212, a database engine 214 and a biometric data push server 216 in various embodiments and combinations thereof.

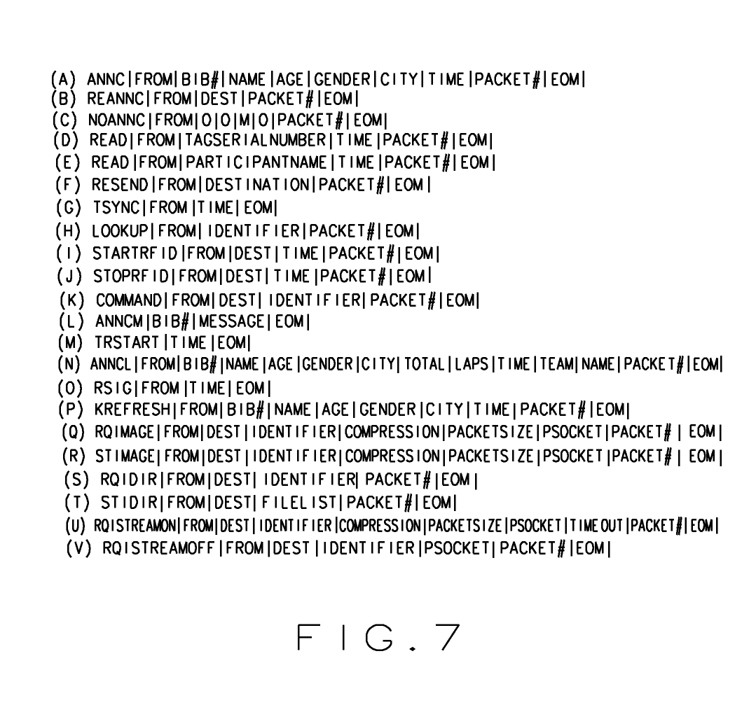

FIG. 7 is a listing of communication messages and formats that are suitable for use by the disclosed system and method. In this case, the timing system 104, the tag reader 106, image capture device 130, image capture interface 152, participant identification system 154, participant registration system 118 and the like can communicate images and image control messages between various components of the system over network 130 using the messages illustrated in FIG. 7. This can include, but is not limited to, RQIMAGE which requests an image from another component, STIMAGE which starts or initiates the capturing or transmission of collected images 150 or images 158, RQSTREAMON and RQSTREAMOFF, which turns on and off the streaming of images 150 or 158 from one system to another, and RQIDIR and STIDIR which requests and stores images 150 and/or 158 in an image directory 220. Of course other messages for communicating collected images 150 or participant images 158 within a system 100, a system 102 or among components therein or with and between the timing system 104, is also possible and considered to be within the scope of the present system.

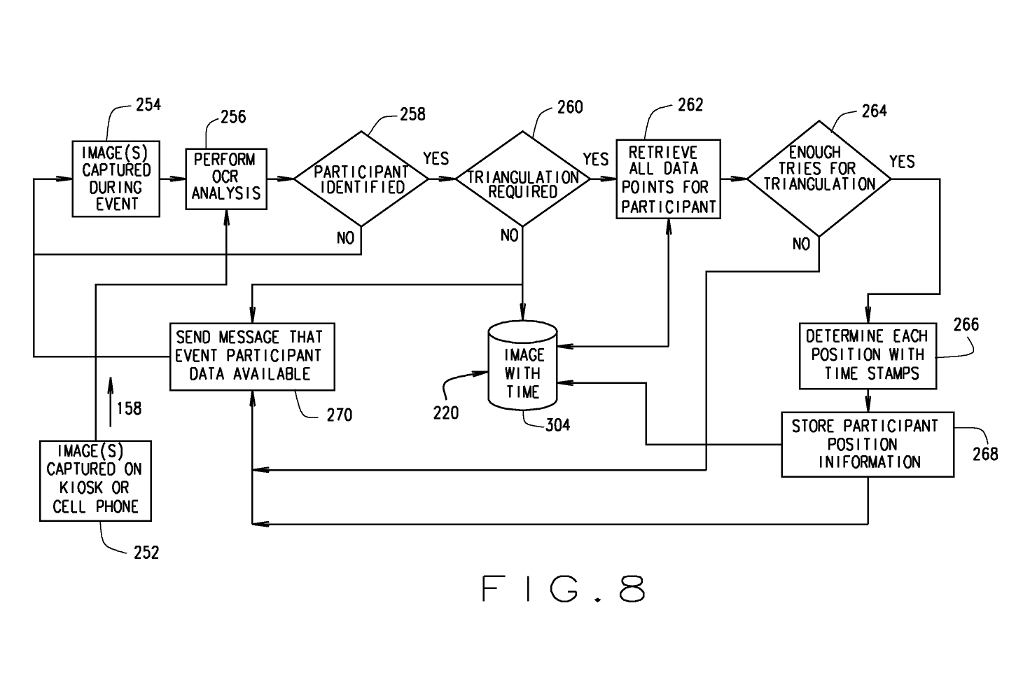

FIG. 8 is a flow diagram of a process 250 for tag reading with image capture and optical character recognition of a bib tag of the participant along with image processing within the timing system according to one embodiment. As shown in this example, a participant image 158 is received or captured in process 252 such as via a participant device 156, registration system 118 or a Kiosk 202 or cell phone 206 by ways of example. The captured images 150 from image capture devices 130 in process 254 and an optical character recognition (OCR) or facial recognition (FR) are performed in process 256 and the participant identification is made in process 258, with processes 256 and 258 being typically performed in the participant identification system 154. If the participant 110 is identified in process 258 is may be possible to determine a particular location of the participant such as via triangulation as provided in process 260.

If triangulation of the position of the participant whose image is captured is required, the process 262 retrieves all data points for the participant to accomplish recognition and location identification in process 264. If such is accomplished in process 264, the timing system 104 determines a position for the participant and the images 150 and associates a time stamp or time for the image 150 in process 266. This is stored with the participant data and determined position data in process 268 in database 304 which can include or be the same as image database 220 or a different database. If in process 256 the participant is not identified, additional images are captured back in process 254. If in step 260 triangulation is not required, such as in the situation that only one participant is at the detection point at the time the image was taken, the image 150 and participant identifier and time data is directly stored in the image database 220. Process 270 manages and administers the data is available for a particular participant 110 such as a copy of the image 158 as well as captured images 150 and time data, which can be used to control the capturing of images in process 254 or the determination if additional images 150 of a participant 110 are required by the timing system 104 or may be desired due to prior arrangement such as requests during registration.

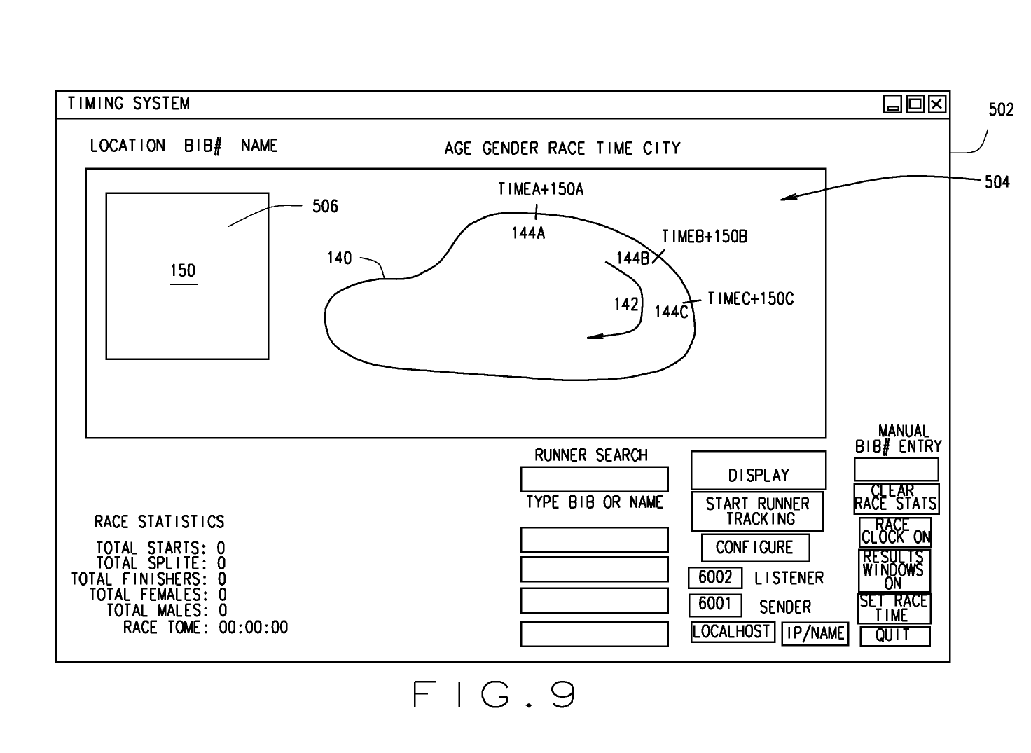

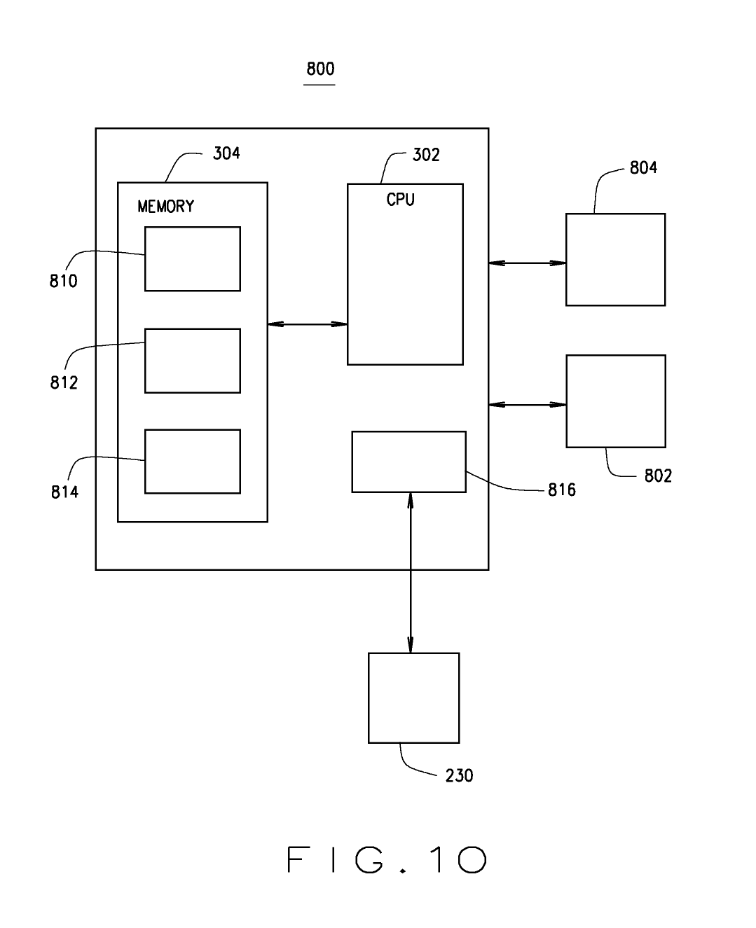

FIG. 9 is a screen shot 502 that is similar but in this embodiment the display 502 includes a mapped illustration of the event route 140 with a visual display of the participant detection points 144A, 144B, and 144C. In this example, the display includes a graphical depiction 504 of the track 140 and the participant's route 142 and times thereon. The track participant 110 following course 140 has displayed the time and image 150 at detection point 144A as Time A and Image 150A, at detection point 144B as Time B and image 150B, and at detection point 144C as Time C and image 150C. In this graphic depiction, a viewer can monitor the participant 110 about the course 140 and also display or monitor their captured images 150. This can also include displaying in window 506 one or of the images 150A, 150B, or 150C such as selected by the user or as the most recent. The display of FIG. 10 or any variations thereof can be provided on any suitable output or reporting system such as described by ways of example in FIG. 3 and as discussed above. These can include a display format for reporting of the biometric data of a participant 110 by the timing system 104 or other image displaying device such as via a webpage 204, a kiosk display monitor 202 or a mobile application 206 as addressed above with regard to FIG. 6 by way of example.

In one or more embodiments, one or more of the following methods and processes, alone or in combination are considered within the scope of the present disclosure. This includes identifying a bib tag number 134 of the participant 110 from the captured image 150 and verifying the bib tag number 134 from a listing of participants. In the timing system 104 or a participant identification system 154, optical character recognition or facial recognition can be performed during identification of the bib tag number 134 or the face 132 of the participant 110. In the RFID tag reader 106 communicate with an RFID tag 112 of the participant 110 and obtain the RFID tag number 114 of the RFID tag 112 in one or more RFID tag reads 114, time stamping each RFID tag read 114, and transmitting over a communication interface a tag read message including the RFID tag number 134 to the timing system 104. The timing system 104 can verify the identity or tag number of the participant 110 as determined from the image 150 with that as determined from the receipt of the RFID tag read 114. The time of passing can be the RFID tag read time 114 based on a successful verification.

The timing system 104 can also determine the RFID tag number 134 within the tag read messages 114, associate the image data 150 in the image capture 143, 145 with the identified participant 110, and store the image data in a database file that is associated with the determined RFID tag number 134. The timing system 104 can provide the image capture system 154 with the RFID tag number 134 and the image capture system 154 can include the received RFID tag number 134 with the image 150. The image capture device 130 can be coupled directly to the RFID tag reader 106 or via the timing system 104 to activate or initiate or otherwise request the capturing of an image 150 by the image capture device 130 when the RFID tag reader 106 detects a RFID tag 134 in a tag read 114. The image capture device 130 can be responsive to such as request. The RFID tag reader 106 can detect the RFID tag number 134 in the tag read 114 approaching the detection point 144, and the RFID tag reader 106 or the timing system 104 or the participant identification system 154 can determine an need for image verification of the participant's identity such as the bib tag number 134 and/or the image capture device 130 can be activated to capture one or more images 150 of the participant associated with the RFID tag number 134 as that participant 110 approaches and/or passes the detection point 144.

The timing system 104 can identify the participant 110 by analyzing a unique identifier such as a QR code and integrate that information with RFID chip reads 114 for the purpose of confirmation of a time at a given detection point 144 along the course 140. The image capture device 130 can time stamp the captured image 150 and transmit the time stamp with the captured image 150 to the participant identification device 154 and/or the timing system 104. The timing system can then determine the time of passing to be the time stamp associated with the captured image 150 as time stamped by the image capture device 150 at the time of taking of the captured image 150.

The timing system 104 can retrieve information on the participant after the identifying of the participant 110 and provide the retrieved information to a communication interface for transmission to a web browser, cell phone, kiosk, television, computer network or system. The timing system 104 can identify the participant 110 by means of optical recognition technology with integrated capabilities such as one or more selected from the group consisting of automatic cropping, digital zoom, and image linking to an RFID tag read, a laser timing read, a GPS location identification or the like.

The timing system 104 can receive a plurality of captured images 150 each with a time stamps and determine numerous data points regarding the participant 110. The timing system 104 can determine at least partially from the received images 150 one or more of a) a route location of the participant 110, b) a velocity or speed of the participant 110, c) a geo location of the participant 110, and a status of the participant 110. The timing system 104 can receives images 150 from multiple image capture devices 130 all associated geographically with each other and identify through triangulation the participant 10 by comparing the data and/or through optical character recognition and consolidation or comparison of several such optical character recognitions. The timing system 104 can initiate a message or communications to an individual or group of individuals as a result of the identifying and providing a notification or copy of the image in such message or communication.

Various embodiment of the system and method described herein can include one or more of the following features, alone or in combination: a) use of one or more devices such as a cell phone camera, video camera, photo camera or any other optical device to capture a single or multiple image(s) during an athletic event and using that information to determine the identity of the event participant; b) use of optical character recognition to determine from an image the unique identity of an individual; c) use of optical character recognition to retrieve information on an athlete for the purpose of providing results on a device such as a browser, cell phone, kiosk, television, or any other output device; d) identification of an individual participant by analyzing a unique identifier such as QR codes and integrating that information with RFID chip reads for the purpose of confirmation of a time at a given point along a course; e) identification an individual at a sports event, in a video or photograph, by means of optical recognition technology with integrated capabilities such as automatic cropping, digital zoom, compression, and other tools used to enhance an image and to link that image to a specific RFID tag read; f) capturing multiple photos or video images with time stamps and to determine numerous data points regarding an event participant, including for example, location as an athlete approaches an RFID detection point, the velocity or speed of an athlete, the geo location of an athlete, etc. These data points could be combined with RFID tag read information, or the data could be used as supplemental information; g) use of one or more camera or optical capture devices to identify an event participant through a means of triangulation by comparing the data identified as the images are analyzed through optical character recognition; h) initiating messages or other communications to an individual or group of individuals as a result of the identity of an event participant being determined through optical recognition. An example would include the ability to notify family members via text messages, Facebook updates or Twitter messages as the participant is identified by analyzing the QR code on a bib as a runner crosses a finish line; i) using backups or primary systems, to incorporate optical character recognition and to identify and send event participant information to a another system as a means of confirming the identity of an individual; j) providing multiple devices to request information on a given event participant by using messages over a network, in which the messages contain optical information. For example, a camera, cell phone, or other optical device could capture information along a race course, send that information in a message packet to a central computing system, and the image could be analyzed using OCR techniques to identify the event participant. Once the participant is identified, a message could be returned to the originating device that contains specific information on the person identified in the image.

### Exemplary Digital Processing System Environment

The systems, platforms, servers, applications, modules, programs, and methods described herein for the event participant management system 102 including the timing system 104 and the biometric module 122 among other components. Each of these can include one or more a digital processing systems 800 as shown in FIG. 10. Each component can include one or more hardware central processing units (CPU) 302 that carry out the functions as described above. The digital processing system 800 includes an operating system configured to perform executable instructions for the operation thereof. In most embodiments, the described digital processing systems 800 includes one or more memory devices 304, a display 802, one or more input devices 804, and in some embodiments can include a sound output device such as an alarm or status or verification signal. In some embodiments, the digital processing system 800 can be connected to one or more data networks 230 that can be a wired network, a mobile network, a wireless network such as a Wi-Fi or a Bluetooth™ network or a wired data network. These data networks 230 can be utilized to access the Internet or an intranet such as for accesses to the World Wide Web or other Internet based services. These can include, but are not limited to such data network accessible systems or applications such as a data storage device, a cloud service, an application server, a terminal or exchange server. In some embodiments, the digital processing system 800 is a non-portable device, such as a server or a desktop computer but in many embodiments it can be a portable device, such as a laptop, tablet computer, a mobile telephone device or a digital audio player.

The systems, platforms, servers, programs, and methods disclosed herein for one or more components or features of the system 100, the event management system 102, RFID reader 106, the timing system 104 or the biometric modules 116 and 122 can include one or more computer programs each of which are composed of sequences of computer executable instructions for the digital processing system's CPU each of which are developed to perform one or more specified tasks. Those of skill in the art will recognize that the computer program may be written in various computer programming languages having one or more sequence of instructions. The computer program can be loaded to the CPU 302 or associated memory 304 via a data network connection 230 or a local memory device, but are increasingly via a data network download. Typically, a computer program such as the operating system 810 is loaded by local memory device 304 such as CD or DVD. In some embodiments, the computer program is delivered from one location to one or more locations and can be increasingly distributed via a cloud computing or application service. In various embodiments, the computer program comprises, in part or in whole, one or more web, web browser, mobile, standalone or applications, extensions, add-ins, or add-ons, or combinations thereof. The systems, platforms, servers, programs, and methods disclosed herein above and throughout include, in various embodiments, software, server, and database modules. The software modules are created by techniques known to those of skill in the art using machines, software, and languages known to the art, some of which are disclosed above.

As noted, a digital processing system 800 typically includes one or more memory or data storage devices 304. The memory 304 stores data including the operating system 810 and application programs 812 as well as operating data 814 on a temporary or permanent basis. In some embodiments, the memory 304 can be volatile and requires power to maintain stored information but can also be non-volatile and retains stored information when the digital processing system 800 is not powered. Further, the memory 304 can be located with the digital processing systems 800 or can be attachable thereto either physically or via a data network connection to a remote memory 304. In some embodiments, the memory 304 can also include flash memory devices, solid state memory, magnetic disk drives, magnetic tape drives, optical disk drives, cloud computing systems and services, and the like.

As noted, the digital processing system 800 includes an operating system 810 configured to perform executable instructions which is stored in memory 304. The operating system can include software, including programs and data, which manages the device's hardware and provides services for execution of software applications/modules. Those of skill in the art will recognize that suitable operating systems can include, by way of non-limiting examples, Apple OS®, Microsoft® Windows®, Microsoft®, Windows®, Apple ® Mac OS X®, UNIX®, and UNIX-like operating systems such as GNU/Linux®. In some embodiments, the operating system can be provided by cloud computing. Those of skill in the art will also recognize that embodiments of the remote control panel and some components of the primary control panel system may also be implemented using suitable mobile smart phones that include mobile operating systems including, by way of non-limiting examples, Nokia® Symbian®, OS, Apple® iOS®, Research In Motion® BlackBerry OS®, Google® Android®, Microsoft® Windows Phone®, OS, Microsoft® Windows Mobile®, OS, Linux®, and Palm® WebOS®.

The digital processing system 800 can include a visual display 802. In some embodiments, the display 802 can be computer controlled cathode ray tube (CRT) or an optical projector, but is increasingly a flat screen such as a liquid crystal display (LCD), a plasma display, a thin film transistor liquid crystal display (TFT-LCD), a light emitting diode (LED) or an organic light emitting diode (OLED). In other embodiments, the display 802 can also be a combination of devices such as those disclosed herein. Typically they are located proximate to one of the digital processing systems 800 but in some embodiments, the display can be remotely located such as a billboard using LED or electrowetting technology.

The digital processing system 800 can also include one or more an input devices 804 that can be a push button, a key switch, a switch, a keyboard, a touch screen or keypad but these can also include a pointing device such as, by way of non-limiting examples, a mouse, touchpad, light pen, pointing stick, trackball, track pad, joystick, game controller, stylus, multi-touch screen, a microphone that captures voice or other sound inputs or an optical image capture device that can capture images or motion or other visual input. In still further embodiments, the input device 804 can be a combination of devices such as those disclosed herein.

In some embodiments, the digital processing system 800 optionally includes one or more sound output devices (not shown but known to those of skill in the art). These sound output devices can be a set of speakers, a pair of headphones, earphones, or ear buds. The speakers can be of any technology including a flat panel loudspeaker, a ribbon magnetic loudspeaker, an electro-acoustic transducer or loudspeaker or a bending wave loudspeaker, or a piezoelectric speaker. In still further embodiments, the sound output device can be a combination of devices such as those disclosed herein.

Such systems utilize one or more communications networks 230 can include wireline communications capability, wireless communications capability, or a combination of both, at any frequencies, using any type of standard, protocol or technology. In addition, in the present invention, communications network 230 can be a private network (for example, a VPN) or a public network (for example, the Internet). A non-inclusive list of exemplary wireless protocols and technologies used by communications network 230 includes BlueTooth™, general packet radio service (GPRS), cellular digital packet data (CDPD), mobile solutions platform (MSP), multimedia messaging (MMS), wireless application protocol (WAP), code division multiple access (CDMA), short message service (SMS), wireless markup language (WML), handheld device markup language (HDML), binary runtime environment for wireless (BREW), radio access network (RAN), and packet switched core networks (PS-CN). An exemplary non-inclusive list of primarily wireline protocols and technologies used by communications network 230 includes asynchronous transfer mode (ATM), enhanced interior gateway routing protocol (EIGRP), frame relay (FR), high-level data link control (HDLC), Internet control message protocol (ICMP), interior gateway routing protocol (IGRP), internetwork packet exchange (IPX), ISDN, point-to-point protocol (PPP), transmission control protocol/internet protocol (TCP/IP), routing information protocol (RIP) and user datagram protocol (UDP). As skilled persons will recognize, any other known or anticipated wireless or wireline protocols and technologies can be used.

In accordance with the description provided herein, a suitable digital processing system 800 can include, by way of example, server computers, desktop computers, laptop computers, notebook computers, tablet computers, mobile phones such as smart phones, audio devices, personal digital assistants, netbook computers, smartbook computers, subnotebook computers, ultra-mobile PCs, handheld computers, Internet appliances, and video game systems both portable and fixed.

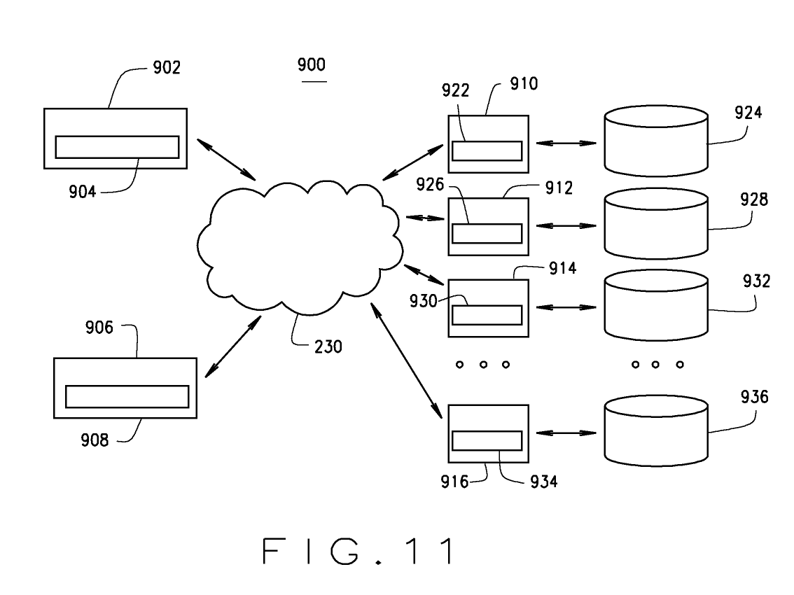

FIG. 11 illustrates a detailed exemplary client-server environment 900. Environment 900 of FIG. 11 includes the aforementioned communications network 230, a plurality of clients 902, 906 and a plurality of servers 910, 912, 914, 916 connected to network 230. The servers 910, 912, 914, 916 are shown connected to a plurality of database servers (DSs). Specifically, server 910 is connected to DS 924, server 912 is connected to DS 928, server 914 is connected to DS 932, and server 916 is connected to DS 936. As one example, the timing system 104 can be implemented as a server 914 and one or more biometric modules 122 can be implemented as a client, 902, 906.

The clients 902, 906 and the servers 910-916 are nodes connected to network 520, defined by their respective information retrieval functions. Client 902 includes a client application 904, which is an information requesting or receiving application associated with client 902, and client 906 includes a client application 908, which is an information requesting or receiving application associated with client 906. Client applications 904, 908 can run either on clients 902, 906, respectively, or can run on another node and are then passed to the clients 902, 906. In one or more embodiments, the client applications 904, 908 are web browsers.

Servers 910-916 include a variety of processes, including operating systems, web server applications and application servers. The operating systems, which can also be called platforms, are the software programs that applications use to communicate with the physical parts of the servers 910-916. Examples of operating systems that can be used with the present invention include: Linux™, Sun Solaris™, Windows NT/2000™, Cobalt RaQ™, and Free BSD™, although any operating systems known or anticipated can be used.

The web server applications are software running on servers 910-916 that make it possible for the client browsers 904, 908 to download stored web pages. These applications also coordinate streaming audio, video, and secure e-commerce, and can be integrated with databases (as described below) for information retrieval. Examples of web server applications that can be used with the present invention include: Apache™, Microsoft's Internet Information Server (IIS)™, O'Reilly & Associates WebSite Pro™, Netscape's FastTrack Server™, and StarNine's WebSTAR™ (for Macintosh), although any operating systems known or anticipated can be used.

The application servers sit on top of the formatting and display languages (for example, HTML) such that a request from clients 902, 906 is generated and translated as a request to the databases. Upon receiving information from databases, the application servers will translate this information back to the formatting and display languages and sent a response back to the browser. In one or more embodiments, the application server software resides at the servers 910-916, although with cross-platform programming technology, software performing the same functions can reside at clients 902, 906 as well. In one or more embodiments, the application servers will insert strings of programming code into the formatting and display language, with client browsers 904, 908 employing interpreters (or a plug-ins) to translate back into the formatting and display language (for example, HTML) to display a page. Examples of application servers that can be used with the present invention include: Cactus™, Cold Fusion™, Cyberprise Server™, Ejipt™, Enterprise Application Server™, Netscape Application Server™, Oracle Application Server™, PowerTier for C++™, PowerTier for Enterprise Java Beans™, Secant Extreme™, Enterprise Server™, SilverStream™, WebEnterprise™, WebSpeed™, and WebSphere™ although any application servers known or anticipated can be used.

Taken together, the web servers and applications servers perform at least these functions: (i) providing an environment upon which server components can run; (ii) functioning as is a main program under which other components run as subroutines; (iii) providing services (for example, security related services, transaction related services), state management, and resources (for example, database connections); (iv) enabling communication with clients 902, 906.

For the convenience of condensing terminology, the aforementioned applications working, which work together on the servers 910-916 (or instead are processed at other nodes and passed to servers 910-916) are referred to as “application servers.” FIG. 11 illustrates applications servers (ASs) 922, 926, 930, 934 respectively can run on clients 910, 912, 914, 916. In operation, client browsers 904, 908 are used to issue requests for information, or queued to transmit information, over network 520. Requests and responses are handled by servers 910-916 via running of ASs 922, 926, 930, 934, which in turn transmit information over network 520 for display by browsers 904, 908.

In one or more embodiments, additional functions required of ASs 922, 926, 930, 934 will be to connect the web servers 910-916 to, for example, back-end data resources such as relational tables, flat files, e-mail messages, and directory servers. In exemplary embodiments, additional programs incorporated in ASs 922, 926, 930, 934 typically called “middleware,” database utilities, or database management systems (DMBS) can be used, among other known or anticipated database methods.

For example, the ASs 922, 926, 930, 934 can include their own internal DBMSs, or DBMSs of other nodes, or the DBMSs labeled database servers (DSs) 924, 928, 932, 936. The DBMS refers to computer software for storing, maintaining, and searching for data in a database. In the present invention, the DBMS can also utilize facilities for increasing reliability and performance, and integrity, such as indexes, logging, and record locking.

In one or more embodiments, the DBMS includes interfaces for searching for and locating particular data items from the database and for presenting the result of these queries to a search engine. A search engine as used herein searches the database in response to a user request, which can be initiated at client browser 902, 906, for example, or at server 922-924, for example, and returns a result to the user, for example in the form of a relational table viewable in browsers 904, 908. The DBMS can refer to any type of database, including a relational DBMS (RDBMS), LDAP™, VSAM™, IMS™, Active Directory Services™, message stores, to name a few.

In one or more embodiments, the DBMS is an RDBMS that uses relational database to retrieve information from the timing system 104 to obtain participant data including biometric data 120. In one or more embodiments, the relational database uses structured query language (SQL™), including SQL defined according to International Standards Organization (ISO) and American National Standards Institute (ANSI) standards, or follow these standards with additional language constructs. In one or more exemplary embodiments, ASs 922-924 are respectively connected to DSs 924-936 via an application programming interface (API), including for example the open database connectivity (ODBC™), Java database connectivity (JDBC™), APIs.

Any types of DBMS platforms can be used in the various systems and components of the systems described herein and methods thereof. Exemplary platforms that can be employed include Sun Microsystems' Java™, 2 Platform, Enterprise Edition (J2EE)™ that contains an Enterprise JavaBeans™. (EJB) server-side component architecture, and Microsoft's Windows™, Distributed interNet Applications Architecture (Windows DNA™), which contains the COM+™ server-side component architecture.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

1-23. (canceled)

24. A system for determining a time of a passing of a participant by a participant detection point on a route of a timed event, the system comprising:
an RFID tag including a participant number as an RFID tag number, the RFID tag being associated with the participant during the event;
an RFID tag reader positioned at the participant detection point communicating with an RFID tag of the participant and receiving the RFID tag number of the RFID tag in one or more RFID tag reads, identifying a time of each RFID tag read, and transmitting the tag read and tag read time;
an image capture device capturing an image of the participant when in proximity to the image capture device positioned at the participant detection point, the image capture device generating a captured image and transmitting the captured image;
a participant identification system having an captured image interface coupled to the image capture device receiving the captured image, the participant identification system analyzing the received captured image including identifying an identification of the participant and transmitting the captured image and the participant's identification; and
a timing system receiving the transmitted captured image and the participant identification from the participant identification system and receiving the tag read and the tag read time from the RFID tag reader, and determining the time of passing of the participant by the participant detection point on the route of the timed event responsive each of the received tag read, the tag read time and the received captured image.

25. The system of claim 24 wherein at least one of the image capture device and the participant identification system includes a clock and associates an image capture time with the captured image, and wherein the image capture time is received by the timing system and the timing system determines the time of passing at least in part based on the image capture time.

26. The system of claim 24 wherein the captured image is an image of a participant number worn by the participant, and wherein the analyzing by the participant identification system includes optical character recognition or object recognition and the identifying includes identifying the participant number of the participant from the captured image, and wherein the timing system receives the identified participant number and determines the participant's number with the determined time of passing.

27. The system of claim 26 wherein the captured image is an image of a QR Code or a Bar Code including the participant number.

28. The system of claim 24 wherein the captured image is an image of a face of the participant, and wherein the analyzing by the participant identification system includes facial recognition and the identifying includes identifying the face of the participant from a comparison of a stored image of the participants face with the captured image and associating the identified face with a participant number, and wherein the timing system receives the identified participant number and determines the participant's number with the generated time of passing.

29. The system of claim 24 wherein the timing system verifies the identification of the participant as determined from the received captured image with that as determined from the received tag read and wherein the timing system determines the time of passing of the RFID tag read time responsive to a successful verification.

30. The system of claim 24 wherein the timing system determines the participant number from the tag read and associates the captured image with the identified participant, and stores the captured image in a database file that is associated with the participant number and/or the RFID tag number.

31. The system of claim 24 wherein the image capture device is coupled to the RFID tag reader, the RFID tag reader system or the timing system generating an image capture request to the image capture device to obtain a captured image responsive to the RFID tag reader receiving a tag read, and wherein the captured image is responsive thereto.

32. The system of claim 24 wherein the RFID tag reader detects the RFID tag number approaching the participant detection point, and at least one of the RFID tag reader, the timing system, and the participant identification system determining a need for capturing an image of the participant with the RFID tag approaching the participant detection point, and generating an image capture request to the image capture device to obtain a captured image, and wherein the captured image is responsive thereto.

33. The system of claim 32 wherein the RFID tag reader receives tag read and the timing system detects the RFID tag number approaching the participant detection point, determines there is an image capture event for capturing an image of the participant with the RFID tag approaching the participant detection point, and generates an image capture request to the image capture device to obtain a captured image, and wherein the captured image is responsive thereto.

34. The system of claim 33 wherein the timing system determines that the image capture event as a function of the timing system verifying of the identification of the participant approaching the participant detection point, the verifying being responsive to a determined image capture event selected from the group of events including a predefined request, a subscription, an RFID tag reader error, a timing system error, and an inability of the tag reader or the timing system to determine the participant number or RFID tag number.

35. The system of claim 24 wherein the participant identification system identities the identification of the participant by analyzing a unique identifier of the captured image and integrates that unique identifier with received tag read for confirming the time of passing.

36. The system of claim 24 wherein the timing system includes an output interface and transmits over the output interface the captured image, the participant identification and the determined time of passing.

37. The system of claim 36 wherein the timing system further retrieves information on the participant after the identifying by the participant identification system and the timing system transmits the retrieved information over the output interface along with the captured image, the participant identification and the determined time of passing.

38. The system of claim 36 wherein the timing system further retrieves information on the participant after the identifying by the participant identification system and the timing system transmits the captured image, the participant identification and the determined time of passing to a network device communicatively coupled to the output interface as defined by the retrieved information.

39. The system of claim 24, further comprising a location device associated with the participant, the location device determining a location of the participant on the route, and wherein the timing system receives the participant location from the location device and the image capture device captures the captured image responsive thereto.

40. The system of claim 24 wherein the timing system determines at least partially from the received captured image one or more of a location of the participant on the route, a speed of the participant along the route.

41. The system of claim 24 wherein there are a plurality of image capture devices associated with the participant detection point, the participant identification system receiving a plurality of captured images from one or more of the plurality of image capture devices and wherein the participant identification system performs the identifying through triangulation or comparing two or more captured images from two or more image capture devices.

42-45. (canceled)

46. A method for determining a time of a passing of a participant by a participant detection point on a route of a timed event, the system comprising:
receiving RFID tag read including an RFID tag number associated with the participant;
identifying an RFID read time for the received RFID tag read;
transmitting the RFID tag read and tag read time;
capturing an image of the participant by an image capture device when in proximity to the image capture device positioned at the detection point on the route, the image capture device generating a captured image and transmitting the captured image;
receiving the captured image;
analyzing the received captured image including identifying an identification of the participant and transmitting the captured image and the participant's identification;
receiving the transmitted captured image and the participant identification;
receiving the tag read and the tag read time; and
determining the time of passing of the participant by the participant detection point on the route of the timed event responsive each of the received tag read, the tag read time and the received captured image.

47. The method of claim 46 wherein the captured image is an image of a participant number worn by the participant, and wherein the analyzing by the participant identification system includes optical character recognition or object recognition and the identifying includes identifying the participant number of the participant from the captured image, and wherein the timing system receives the identified participant number and determines the participant's number with the determined time of passing.

48. The method of claim 47 wherein the captured image is an image of a QR Code or a Bar Code including the participant number.

49. The method of claim 46 wherein the captured image is an image of a face of the participant, and wherein the analyzing by the participant identification system includes facial recognition and the identifying includes identifying the face of the participant from a comparison of a stored image of the participants face with the captured image and associating the identified face with a participant number, and wherein the timing system receives the identified participant number and determines the participant's number with the generated time of passing.

50. The method of claim 46, further comprising verifying the identification of the participant as determined from the received captured image with that as determined from the received tag read and wherein determining the time of passing of the RFID tag read time is responsive to a successful verification.

51. The method of claim 46, further comprising determining the participant number from the tag read associating the captured image with the identified participant, and storing the captured image in a database file that is associated with the participant number and/or the RFID tag number.

52. The method of claim 46, further comprising generating an image capture request to the image capture device to obtain a captured image responsive to the RFID tag reader receiving a tag read, and wherein the capturing of the captured image is responsive thereto.

53. The method of claim 46, further comprising detecting via an RFID tag reader the approaching of the participant to the participant detection point, determining a need for capturing an image of the participant with the RFID tag approaching the participant detection point, and generating an image capture request to the image capture device to obtain a captured image, and wherein the capturing of the captured image is responsive thereto.

54. The method of claim 53, further comprising receiving the tag read at the RFID tag reader, and detecting by the timing system the RFID tag number that is approaching the participant detection point, determining an image capture event for capturing an image of the participant with the RFID tag approaching the participant detection point, and generating an image capture request to the image capture device to obtain a captured image, and wherein the capturing of the captured image is responsive thereto.

55. The method of claim 54 wherein determining the image capture event is a function of the timing system verifying of the identification of the participant approaching the participant detection point, the verifying being responsive to a determined image capture event selected from the group of events including a predefined request, a subscription, an RFID tag reader error, a timing system error, and an inability of the tag reader or the timing system to determine the participant number or RFID tag number.

56. The method of claim 46, further comprising identifying the identification of the participant by analyzing a unique identifier of the captured image and integrating the unique identifier with received tag read for confirming the time of passing.

57. The method of claim 46, further comprising transmitting over an output interface of the timing system the captured image, the participant identification and the determined time of passing.

58. The method claim 57, further comprising retrieving information on the participant after the identifying of the participant and transmitting the retrieved information over the output interface along with the captured image, the participant identification and the determined time of passing.

59. The method of claim 46, further comprising retrieving information on the participant after the identifying of the participant and transmitting the captured image, the participant identification and the determined time of passing to a network device communicatively coupled to an output interface as defined by the retrieved information.

60. The method of claim 46, receiving a location of the participant on the route from a participant location device, wherein capturing of the captured image is responsive thereto.

61. The method of claim 46, further comprising determining at least partially from the received captured image one or more of a location of the participant on the route, a speed of the participant along the route.

62. The method of claim 46 wherein there are a plurality of image capture devices associated with the participant detection point, further comprising receiving a plurality of captured images from one or more of the plurality of image capture devices, wherein the identifying includes triangulation or comparing of two or more captured images from two or more image capture devices.
